(19) United States
(12) Patent Application Publication
(10) Pub. No.: US 2025/0377439 A1
(43) Pub. Date: Dec. 11, 2025

(54) Housing Structure for a Radar Device of a Vehicle

(71) Applicant: Illinois Tool Works Inc., Glenview, IL (US)

(72) Inventors: Eyüp Aslan, Hannover (DE); Marian Cristea, City Ghimbav (DE); Salvatore Cicero, Oberthulba (DE); Fredrik Andersson, Västeräs (DE)

(21) Appl. No.: 19/221,154

(22) Filed: May 28, 2025

(30) Foreign Application Priority Data
Jun. 10, 2024 (DE) 10 2024 116 135.3

(51) Int. Cl. G01S 7/02; G01S 7/40; G01S 13/931; H05B 3/36; H05B 3/86

(52) U.S. Cl. CPC G01S 7/027; G01S 7/4043; G01S 13/931; H05B 3/36; H05B 3/86; G01S 2013/93271

(57) ABSTRACT

The disclosure relates to a housing structure (1) for a vehicle radar system. The housing includes a radiation window (2), made at least partly of plastic, which allows radar signals to pass through. Surrounding the window is a frame (3) with side walls that are positioned in a different direction than the window itself. The housing also includes a heating system (4), which has at least one resistance heater. This heater is placed partly on the side walls of the frame and partly on or near the radiation window to help keep the area clear, likely from ice or condensation.

### RELATED APPLICATIONS

The present application claims the benefit of German Patent Application No. 10 2024 116 135.3, filed Jun. 10, 2024, titled “Housing Structure for a Radar Device of a Vehicle,” the contents of which are hereby incorporated by reference.

### BACKGROUND

Radar apparatuses, in particular front radar apparatuses, are typically exposed to the effects of weather conditions, such as snow, ice, or rain/wet, which affects object image resolution of radar signals. Furthermore, weather-related effects on the radar signal characteristic are known, which, in the context of a downstream dynamic image analysis, can lead to incorrect information regarding the travel horizon/sampling field, such that, for example, in the case of freezing rain, weather conditions are present that adversely affect radar sensory detection and thus object detection, although the weather conditions make the reliability in the vehicle necessary.

In particular, it must be ensured that the radiation window of the housing of the radar apparatus, through which electromagnetic waves transmitted from and/or received by the radar apparatus, is as fully freed of moisture and ice as possible.

For this purpose, for example, it is known from the publication DE 10 2013 214 286A1 to direct warm air that serves for defrosting or de-icing the radiation window of a radar sensor to an edge region of the radiation window via an air exhalation nozzle connected to the vehicle's air conditioning system via an air outlet hose.

However, such an approach to defrosting and/or de-icing the radiation window of a radar sensor results in relatively high additional manufacturing and assembly costs. In addition, the vehicle must be configured accordingly, so that the additional air outlet hose, which also requires an additional design space, can be accommodated.

A further challenge is the trend in automotive technology to employ a 4D imaging radar, which can replace camera, radar, and LIDAR in order to enable autonomous driving. 4D radars determine the height of objects in addition to speed, distance, and horizontal angles. They have a high resolution, can detect, separate, and classify and are not impaired by poor light or weather conditions. Compared to LIDAR sensors, they do not need a dedicated front end for their various distances of up to about 300 m.

However, the introduction of 4D radar technology is not without difficulty. This is in particular because a 4D radar requires a significantly larger radiation window in the housing structure of the radar apparatus compared to classical radar sensors. Thus, the average size of the radiation window in classical radar apparatuses is about 50 to 70 cm². However, a 4D radar requires a radiation window size of greater than 200 cm², typically even greater than 400 cm².

The outer surface of the necessary radiation window requires a new approach to heating the radiation window in order to effectively prevent ice formation.

In conventional radar apparatuses with a relatively small radiation window in the order of, for example, about 50 to 70 cm², heating is carried out using heating wires that are integrated in the material of the radiation window. In order to be able to sufficiently temperature-control larger radiation windows with conventional wire heaters, it would be necessary to increase the heating wire density in the material of the radiation window, which however negatively affects the transmissivity of the radiation window. In addition, there is a risk that the heating wire will melt.

The region between the radiation window and the frame region of the housing structure is also problematic, because the heating wires here must be laid around an edge region. This inevitably leads to a plastic deformation of the heating wire in the edge region, which creates a potential weak spot, because in this region the heating wire tends to melt.

Based on this problem, the problem addressed by the disclosure is thus to specify a solution in which the radiation window of the housing structure of a radar apparatus can be reliably defrosted and/or defrosted in an easily realized yet effective manner, wherein this is also ensure in the case of larger radiation windows, in particular for radiation windows of a housing structure of a 4D radar.

### SUMMARY

The present disclosure relates generally to a housing structure, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates schematically and in a plan view, an exemplary embodiment of the housing structure according to the disclosure.

FIG. 2 illustrates schematically, a longitudinal sectional view along the line C-C in FIG. 1.

FIG. 3 illustrates schematically, a detailed view of the longitudinal sectional view according to FIG. 2.

FIG. 4 illustrates schematically, a longitudinal sectional view along the line A-A in FIG. 1.

FIG. 5 illustrates schematically, a detailed view of the longitudinal sectional view of FIG. 4.

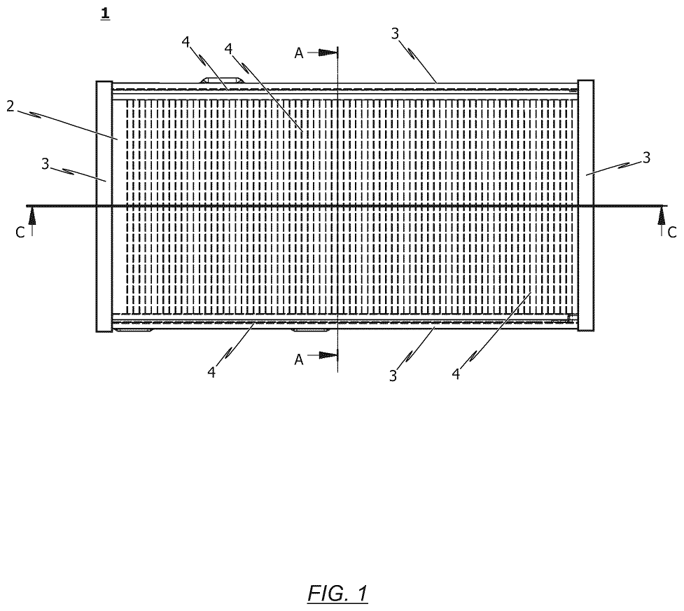

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein is not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent to or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates to a radar apparatus for a vehicle, comprising at least one antenna element and a housing structure having a radiation window, wherein the radiation window is configured to allow passage of electromagnetic waves transmitted from and/or received by the radar apparatus.

The radar apparatus is in particular a front radar sensor as part of a driver assistance system for implementing driving functions for greater comfort, safety, and automated driving.

Particularly when driving automatically, the vehicle must always be able to reliably detect and react to objects and people. A corresponding radar apparatus, which is in particular configured as a front radar apparatus, allows precise, fast, and robust object detection and object tracking due to high range, wide opening angle, high angle separability, and optionally its own chirp sequence modulation, so that the radar apparatus is particularly suitable for complex traffic situations.

Generally, a radar apparatus on a vehicle serves as a detection system to determine a distance, angle, or speed of an object in the vicinity of the vehicle with respect to the radar apparatus. The radar apparatus typically comprises at least one transmitter generating electromagnetic waves in the radiowave or microwave range, at least one transmitter antenna, at least one receiver antenna, a receiver, and a processor. Radiowaves transmitted by the radar apparatus are reflected by the object in an environment of the vehicle. The return signal, i.e. the reflected radio waves, is received by the radar apparatus and provides information about the location and the speed of the object.

The word “radar” is an abbreviation and refers to radio detection and distance measurement.

The disclosure relates in particular to a housing structure for a radar apparatus of a vehicle, wherein the housing structure comprises a radiation window formed at least partially or regionally from a plastic material.

In particular, in this context, a material permittivity and dielectric constant of the plastic material of the radiation window can be selected such that electromagnetic waves emitted/transmitted and/or received from the radar apparatus can preferably pass through the radiation window at least nearly undamped, and in particular with a maximum dampening of 6 dB, in a single pass.

The housing structure in particular forms a cover element, which is configured to allow passage of electromagnetic waves transmitted and/or received by at least one antenna (receiving antenna and/or transmitter antenna) of the radar apparatus through the radiation window. Therefore, at least the radiation window of the housing structure is at least substantially invisible to the electromagnetic waves transmitted from and/or received by the radar apparatus.

The housing structure, and in particular the region of the housing structure in which the radiation window is formed, is typically arranged upstream of the antennas of the radar apparatus, so that this region can be referred to as a radar dome or radome.

In particular, a material permittivity and dielectric constant of the plastic material of the radiation window are selected such that electromagnetic waves transmitted and/or accommodated from the radar apparatus can preferably pass through the radiation window at least nearly undamped.

In this context, “nearly undamped” means in particular that the electromagnetic waves transmitted from and/or received by the radar apparatus can pass through the radiation window with a damping of max. 6 dB in a single pass.

In addition to the radiation window, the housing structure comprises further parts, which are in particular also made of plastic, although it is also contemplated that the further parts of the housing structure are made of another material, for example metal.

In particular, the housing structure comprises a frame region at least partially or regionally surrounding the radiation window, wherein side walls of the frame region extend in a direction that is different from the direction in which the radiation window extends.

The housing structure according to the disclosure is wherein it comprises a heating apparatus. The heating apparatus comprises at least one resistance heater, which is arranged at least partially or regionally at or on the side walls of the frame region and at least partially or regionally at or on the radiation window.

The advantages achievable with the solution according to the disclosure are obvious: due to the fact that the heating apparatus, and in particular the at least one resistance heater of the heating apparatus, is arranged not only on the radiation window itself, but in particular also at or on the side walls of the frame region of the housing structure, a significantly larger surface area of the housing structure is actively heated with the heating apparatus, and in particular with the at least one resistance heater, compared to the surface area of the radiation window, which is to be kept ice-free, in particular.

In other words, the surface area of the housing structure heated with the heating apparatus is larger than the actual surface area to be heated, namely the radiation window of the housing structure.

By heating a plurality of surfaces, namely the side surfaces of the frame region on the one hand and the surface of the radiation window on the other hand, a regular heating of the volume surrounding the housing structure can be achieved, in particular with a regular average temperature distribution.

Because the side walls of the frame region extending in a direction that is different from the direction in which the radiation window extends are heated, and because additionally the radiation window is heated, multi-surface heating occurs with the consequence that air convection occurs in the volume enclosed by the housing structure.

Stated another way, this means that at least the portion of the heating apparatus that heats the side walls of the frame region serves in the transferred sense as a type of “convection heater,” because the heat from the side walls of the frame region is transferred by convection to the air contained in the volume enclosed by the housing structure. The air is heated by the side walls of the frame region and consequently rises upwards, as a result of which convective air circulation occurs in the volume enclosed by the housing structure, so that this convection additionally heats the radiation window.

The convection also decisively contributes to the housing structure being heated evenly overall and no heat peaks being able to occur, in particular at the edge region of the radiation window.

This in turn has the advantage that the heating apparatus provided for the radiation window can be designed with relatively small dimensions, so that the transmissivity of the radiation window is not weakened, or at least not significantly weakened, by the provision of the heating apparatus.

According to implementations of the housing structure according to the disclosure, it is provided that heating apparatus is configured such that it provides a higher heating power in an edge region of the radiation window and/or in a transition region between the side walls of the frame region and the radiation window, compared to the heating power that the heating apparatus outputs in the region of the radiation window.

This can be realized in particular by the fact that, in the transition region between the side walls of the frame region and the radiation window, the resistance heater has larger dimensions compared to the dimensions of the resistance heater in or on the radiation window.

Due to the fact that, in this design variant, the edge region of the radiation window and/or the transition region between the side walls of the frame region and the radiation window is heated more strongly than the radiation window itself, it is achieved that in the case of an iced radiation window, primarily only the edge region of the ice layer is warmed, so that the ice layer can then slide away from the radiation window.

Thus, despite a relatively low heating power, an effective de-icing of the radiation window is possible.

Alternatively or in addition to the aforementioned design variant, according to one embodiment of the disclosure, it is provided that the heating apparatus is configured in such a way that, in terms of surface area, it provides a higher heating power in the region of the side walls of the frame region compared to the heating power that the heating apparatus outputs in the region of the radiation window.

In this design variant, the finding is based on the fact that the heating apparatus, or the at least one resistance heater of the heating apparatus, can be designed to have larger dimensions in the region of the side walls of the frame region compared to the heating apparatus or the resistance heater on or on the radiation window without any problems, because no consideration of the transmissivity must be made on the side walls of the frame region. On the other hand, due to the convection, the (increased) heating of the side walls of the frame region makes a positive contribution to the heating of the radiation window.

According to one aspect of the disclosure, it is provided that the at least one resistance heater is configured as a heating foil, in which an electrically conductive coating is applied as a heating element on a substrate, preferably with the aid of a printing technique, in particular by screen printing or ink jet printing.

This design variant for the resistance heater has significant advantages compared to conventional resistance heaters based on thin-wire technology. By using an electrically conductive coating as the heating element, a directional heating is possible. A resistance wire radiates thermal energy in all directions. This is not the case when conductor tracks made of an electrically conductive coating are used as the heating elements. In the case of conductor tracks, heat radiation occurs in a main direction, because the conductor track structure is generally designed to be relatively flat.

Due to the fact that a directional heating is possible with the aid of the electrically conductive coating, a majority of the thermal energy generated during operation of the resistance heater can specifically be used for the purpose of de-icing or de-de-frosting the radiation window.

By applying the electrically conductive coating to a carrier using a printing technique, in particular a screen printing or ink jet printing technique, the pattern of the conductor coating can be individually chosen to specifically heat the side walls of the frame region more strongly compared to the radiation window itself.

By using printed conductor tracks as the heating elements, a weakening of the resistance heater can further be effectively prevented, in particular in a transition region/edge region between the side walls of the frame region and the radiation window. In the transition region, the printed conductor tracks can easily be made wider as well.

The substrate on which the electrically conductive coating is applied with the aid of a printing technique is in particular a flexible plastic foil, whose material permittivity and dielectric constant are selected in such a way that electromagnetic waves transmitted and/or received from the radar apparatus can preferably pass nearly undamped, and in particular with a maximum dampening of 6 dB, in a single pass.

The foil with the printed electrically conductive coating can then be connected to the body of the housing structure by attaching the flexible plastic foil from the inside to the inner surface of the body of the housing structure, and preferably gluing it thereto. In particular, it is expedient here to subsequently overmold the laminate with a plastic material in order to achieve a complete encapsulation of the plastic foil with the printed electrically conductive coating.

In particular, it is thus possible that the at least one heating apparatus comprises printed conductor tracks as heating elements, wherein, in a transition region between the side walls of the frame region and the radiation window, a width of the printed conductor tracks is greater than a width of the conductor tracks arranged at or on the radiation window.

Preferably, the printed conductor tracks serving as heating elements are relatively flat. In this context, it is expedient that a conductor track width corresponds to at least five times, and preferably at least ten times, the conductor path thickness, in order to thus enable a directional heating.

According to implementations of the housing structure according to the disclosure, it is provided that the heating apparatus comprises a plurality of printed conductor track structures, which are at least partially connected in parallel with one another. With such a parallel circuit, it can be achieved that the electrical resistance of the printed conductor track structures does not become too high, so that failure of the track structures by “melting” is effectively prevented.

With regard to the manufacture of the housing structure according to the disclosure, it is contemplated in particular that the housing structure with the heating apparatus is manufactured in the course of additive manufacturing.

The housing structure according to the disclosure is in particular suitable for the use of 4D radar technology, because the radiation window can have a surface area of greater than 200 cm² and in particular a surface area of greater than 300 cm² and even a surface area of greater than 400 cm², wherein a safe de-icing is still ensured by the heating apparatus.

According to embodiments of the housing structure according to the disclosure, the housing structure is manufactured in a plastic injection-molding process as a multi-layered body, wherein the multi-layered body comprises an outer layer made of at least substantially radar-transparent plastic material, and a further (middle) layer made of a plastic material, wherein the heating apparatus is at least regionally configured in the middle layer. The outer layer of the multi-layered body thus forms the base body of the housing structure. For example, the middle layer forms the heating foil.

It is optionally contemplated that the multi-layered body also comprises an inner layer made of a plastic material, which covers the middle layer with the heating apparatus and thus hermetically encapsulates the heating apparatus.

It is expedient here that the plastic material of the outer layer is identical or at least substantially identical to the plastic material of the middle and/or inner layer.

According to preferred implementations of the housing structure according to the disclosure, it is provided that a surface area of the housing structure covered by the heating apparatus is larger than a surface area of the radiation window.

Preferably, the heating apparatus is configured such that, in an edge region of the radiation window and/or in a transition region between the side walls of the frame region and the radiation window, the apparatus supplies a higher heating power in terms of surface coverage compared to the heating power supplied by the heating apparatus in the region of the radiation window, such that, during operation of the heating apparatus, more heat is or can be output from the heating apparatus per unit surface area in an edge region of the radiation window and/or in a transition region between the side walls of the frame region and the radiation window (per unit of time) than at the radiation window.

For example, the heating apparatus can be configured such that, in the region of the side walls of the frame region, the apparatus supplies a higher heating power in terms of surface coverage compared to the heating power supplied by the heating apparatus in the region of the radiation window, such that, during operation of the heating apparatus, more heat is or can be output per unit surface area from the heating apparatus in the region of the side walls of the frame region per unit of time than at the radiation window.

According to implementations of the housing structure according to the disclosure, it is provided that the at least one resistance heater is configured as a heating foil, in which an electrically conductive coating is applied as a heating element on a substrate, preferably with the aid of a printing technique, in particular by screen printing or ink jet printing.

In this context, it is expedient that the in particular flexible plastic foil is connected to a region of the radiation window and to the side walls of the frame region in a material-locking manner, in particular by way of adhesive bonding and/or welding.

The in particular flexible plastic foil is configured to be encapsulated against moisture, in particular via a circumferential welding or adhesive connection.

On the other hand, it is contemplated that the in particular flexible plastic foil is connected to a region of the radiation window and to the side walls of the frame region, in particular by means of a positive-locking connection, in particular a clip connection, and wherein the in particular flexible plastic foil is configured to be encapsulated against moisture, in particular via a circumferential welding or adhesive connection.

In principle, it is expedient that the at least one heating apparatus comprises conductor tracks printed with an electrically conductive ink as heating elements, wherein, regionally or portions of the printed conductor tracks, a density of electrically conductive particles in the electrically conductive ink varies, in particular such that, in a transition region between the side walls of the frame region and the radiation window, an electrical conductivity of the printed conductor tracks is greater than an electrical conductivity of the conductor tracks arranged at or on the radiation window.

The disclosure further relates to an assembly for temperature-controlling a radar sensor in a vehicle, in particular for as-needed de-frosting and/or de-icing, wherein the assembly comprises at least one radar sensor and a housing associated with the at least one radar sensor, in which housing the at least one radar sensor is at least partially or regionally received.

The assembly according to the disclosure is characterized in particular in that the housing associated with the at least one radar sensor is at least partially or regionally formed by a housing structure of the aforementioned type according to the disclosure.

As already stated, because the housing structure, and in particular the heating apparatus of the housing structure, allows for a convection heating, it is advantageous that convection openings are configured in the housing associated with the at least one radar sensor. Through these convection openings, the air contained in the volume enclosed by the housing structure can communicate with the external atmosphere in order to enable thermal management. By convection, heat can be conveyed out via the convection openings in the housing, which is particularly desirable in warm seasons, because the radar sensor itself releases heat during operation, and an overheating of the radar sensor must be avoided.

The disclosure further relates to a radar apparatus for a vehicle, wherein the radar apparatus comprises at least one antenna element and a housing structure of the aforementioned type according to the disclosure. The radiation window of the housing structure is designed to allow passage of electromagnetic waves, which have been emitted from and/or received by the at least one antenna element of the radar apparatus, through the radiation window.

The at least one antenna element is preferably arranged adjacent to the radiation window.

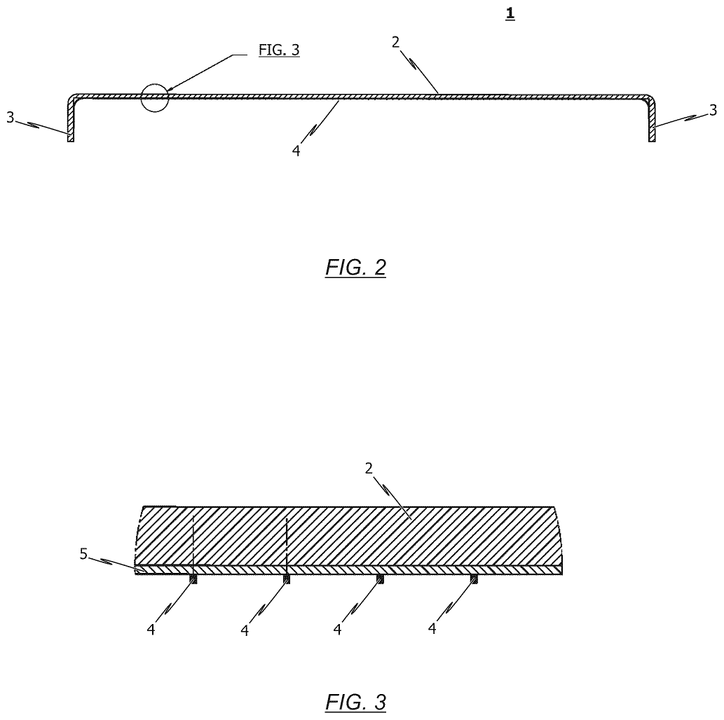

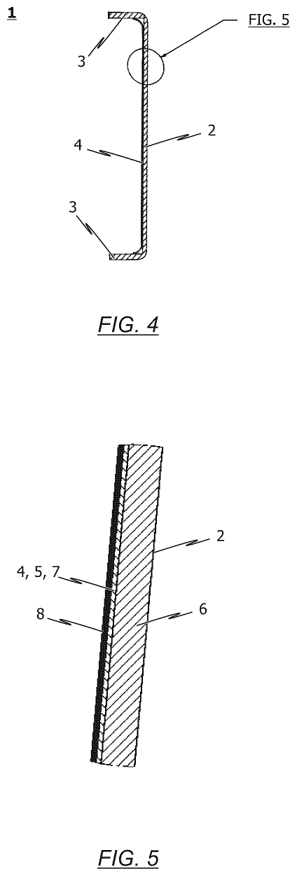

The exemplary embodiment of the housing structure 1 according to the disclosure, as shown in the accompanying drawings, comprises a radiation window 2 formed at least partially or regionally from a plastic material, as well as a frame region 3 surrounding the radiation window 2, having side walls. The side walls of the frame region 3 extend in a direction that is different from the direction in which the radiation window 2 extends (cf. FIG. 2 and FIG. 4).

A material permittivity and dielectric constant of the plastic material of the radiation window 2 are selected such that electromagnetic waves emitted and/or received from the radar apparatus (not shown in the drawings) can preferably pass through the radiation window 2 at least nearly undamped, and in particular with a maximum dampening of 6 dB, in a single pass.

For as-needed de-frosting or de-icing of the radiation window 2, the housing structure 1 comprises a heating apparatus 4, wherein this is a heating apparatus comprising at least one resistance heater, which is arranged at least partially or regionally at or on the side walls of the frame region 3 and at least partially or regionally at or on the radiation window 2 of the housing structure 1.

Specifically, the resistance heater 4 is configured as a heating foil, in which an electrically conductive coating is applied as a heating element on a substrate 5, preferably with the aid of a screen printing technique.

The substrate 5 is preferably an in particular flexible plastic foil, whose material permittivity and dielectric constant are selected in such a way that electromagnetic waves transmitted and/or received from the radar apparatus can preferably pass nearly undamped, and in particular with a maximum dampening of 6 dB, in a single pass.

The in particular flexible plastic foil (substrate 5) is connected to a region of the radiation window 2 and to the side walls of the frame region 3 in a material-locking manner, in particular by way of adhesive bonding.

As heating elements, the heating apparatus 4 comprises printed conductor tracks. In a transition region between the side walls of the frame region 3 and the radiation window 2, a width of the printed conductor tracks is preferably greater than a width of the conductor tracks arranged at or on the radiation window 2.

In particular, it is contemplated in this context that the at least one heating apparatus 4 comprises printed conductor tracks as heating elements, wherein a conductor track width corresponds to at least five times and preferably at least ten times the conductor track thickness.

In particular on the frame region 3 of the housing structure 1, the heating apparatus 4 can comprise a plurality of printed conductor track structures, which are at least partially connected in parallel to one another.

The heating apparatus 4 of the exemplary embodiment of the housing structure 1 according to the disclosure is preferably configured such that it provides a higher heating power in an edge region of the radiation window 2 and/or in a transition region between the side walls of the frame region 3 and the radiation window 2, compared to a heating power that the heating apparatus 4 outputs in the region of the radiation window 2.

In addition, in terms of surface area, the heating apparatus 4 is preferably configured to provide a higher heating power in the region of the side walls of the frame region 3 compared to the heating power that the heating apparatus 4 outputs in the region of the radiation window 2.

As can be seen in particular in the sectional view in FIG. 5, the heating foil is preferably configured to be encapsulated with a plastic layer.

In other words, the housing structure 1 is configured as a multi-layered body comprising an outer layer 6 made of an at least substantially radar-transparent a plastic material, a middle layer 7 of a plastic material, and an inner layer 8.

The middle layer 7 comprises the heating apparatus 4, while the inner layer 8 encapsulates/covers the middle layer 7 with the heating apparatus 4.

Preferably, the radiation window 2 of the housing structure 1 shown in the drawings has a surface area of 400 cm² or greater.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMERALS

1 Housing structure
2 Radiation window
3 Frame region/side wall
4 Heating apparatus/resistance heater
5 Plastic foil/substrate
6 Outer layer
7 Middle layer
8 Inner layer

What is claimed is:

1. A housing structure (1) for a radar apparatus of a vehicle, the housing structure (1) comprising:
a radiation window (2) formed at least partially or regionally from a plastic material that is at least partially or regionally transparent for electromagnetic waves that are transmitted and/or received by the radar apparatus,
wherein the housing structure (1) comprises a frame region (3) surrounding the radiation window (2) and having side walls, wherein the side walls of the frame region (3) extend in a direction that is different than the direction in which the radiation window (2) extends, and
wherein the housing structure (1) comprises a heating apparatus (4), wherein the heating apparatus (4) comprises at least one resistance heater, which is arranged at least partially or regionally at or on the side walls of the frame region (3) and at least partially or regionally at or on the radiation window (2).

2. The housing structure (1) according to claim 1,
wherein a surface of the housing structure (1) covered by the heating apparatus (4) is larger than a surface of the radiation window (2).

3. The housing structure (1) according to claim 1,
wherein the heating apparatus (4) is configured such that, in an edge region of the radiation window (2) and/or in a transition region between the side walls of the frame region (3) and the radiation window (2), the apparatus supplies a higher heating power in terms of surface coverage compared to the heating power supplied by the heating apparatus (4) in the region of the radiation window (2), such that, during operation of the heating apparatus (4), more heat is output per unit area from the heating apparatus (4) in an edge region of the radiation window (2) and/or in a transition region between the side walls of the frame region (3) and the radiation window (2) than is output at the radiation window (2).

4. The housing structure (1) according to claim 1,
wherein the heating apparatus (4) is configured such that, in the region of the side walls of the frame region (3), the apparatus supplies a higher heating power in terms of surface coverage compared to the heating power supplied by the heating apparatus (4) in the region of the radiation window (2), such that, during operation of the heating apparatus (4), more heat is output per unit area from the heating apparatus (4) in the region of the side walls of the frame region (3) than is output at the radiation window (2).

5. The housing structure (1) according to claim 1,
wherein the at least one resistance heater is configured as a heating foil, in which an electrically conductive coating is applied as a heating element on a substrate (5), preferably with the aid of a printing technique by screen printing or ink jet printing.

6. The housing structure (1) according to claim 5,
wherein the substrate (5) is a flexible plastic foil, whose material permittivity and dielectric constant are selected in such a way that electromagnetic waves transmitted and/or received from the radar apparatus can preferably pass nearly undamped, and with a maximum dampening of 6 dB, in a single pass.

7. The housing structure (1) according to claim 5,
wherein the flexible plastic foil is connected to a region of the radiation window (2) and to the side walls of the frame region (3) in a material-locking manner by way of adhesive bonding and/or welding.

8. The housing structure (1) according to claim 7,
wherein the flexible plastic foil is configured to be encapsulated against moisture via a circumferential welding or adhesive connection.

9. The housing structure (1) according to claim 5,
wherein the flexible plastic foil is connected to a region of the radiation window (2) and to the side walls of the frame region (3) via a positive-locking connection and wherein the flexible plastic foil is configured to be encapsulated against moisture via a circumferential welding or adhesive connection.

10. The housing structure (1) according to claim 1,
wherein the at least one heating apparatus (4) comprises printed conductor tracks as heating elements, wherein, in a transition region between the side walls of the frame region (3) and the radiation window (2), a width of the printed conductor tracks is greater than a width of the conductor tracks arranged at or on the radiation window (2).

11. The housing structure (1) according to claim 1,
wherein the at least one heating apparatus (4) comprises conductor tracks printed with an electrically conductive ink as heating elements, wherein, in regions or portions of the printed tracks, a density of electrically conductive particles in the electrically conductive ink varies such that, in a transition region between the side walls of the frame region (3) and the radiation window (2), an electrical conductivity of the printed conductor tracks is greater than an electrical conductivity of the conductor tracks arranged at or on the radiation window (2).

12. The housing structure (1) according to claim 1,
wherein the at least one heating apparatus (4) comprises printed tracks as heating elements, wherein a conductor track width corresponds to at least five times and preferably at least ten times the conductor track thickness.

13. The housing structure (1) according to claim 1,
wherein the heating apparatus (4) comprises a plurality of printed conductor track structures, which are at least in part connected in parallel.

14. The housing structure (1) according to claim 1,
wherein the heating apparatus (4) comprises a plurality of printed conductor track structures, which are at least in part electrically connected in series.

15. The housing structure (1) according to claim 1,
wherein the housing structure (1) is manufactured with the heating apparatus (4) by way of an additive manufacturing process.

16. The housing structure (1) according to claim 1,
wherein the radiation window (2) has a surface area of at least 200 cm².

17. The housing structure (1) according to claim 1,
wherein the housing structure (1) is configured as a multi-layer body produced in a plastic injection-molding process, wherein the multi-layer body comprises the following:
an outer layer (6) consisting of an at least substantially radar-transparent plastic material;
a middle layer (7) consisting of a plastic material, wherein the heating apparatus (4) is configured at least regionally in the middle layer; and
optionally, an inner layer (8) consisting of a plastic material covering the middle layer (7) with the heating apparatus (4),
wherein the plastic material of the outer layer (6) is preferably identical or at least substantially identical to the plastic material of the middle and/or inner layer (7, 8).

18. The housing structure (1) according to claim 1,
wherein the housing structure (1) is configured as a multi-layered body, wherein the multi-layered body comprises the following:
an outer layer (6) consisting of an at least substantially radar-transparent plastic material;
a middle layer (7) consisting of a plastic material, wherein the heating apparatus (4) is configured at least regionally in the middle layer; and
optionally, an inner layer (8) consisting of a plastic material covering the middle layer (7) with the heating apparatus (4),
wherein the middle layer (7) with the heating apparatus (4) is connected with the outer layer (6), via a positive-locking connection, preferably a clip connection, and wherein the middle layer (7) with the heating apparatus (4) is encapsulated and/or sealed against moisture when in its state of being connected to the outer layer (6).

19. The housing structure (1) according to claim 1,
wherein a material permittivity and dielectric constant of the plastic material of the radiation window (2) are selected such that electromagnetic waves transmitted and/or received from the radar apparatus can preferably pass through the radiation window (2) at least nearly undamped, and with a maximum dampening of 6 dB, in a single pass.

20. An assembly for tempering a radar sensor in a vehicle for as-needed defrosting and/or deicing, wherein the assembly comprises the following:
at least one radar sensor; and
a housing associated with the at least one radar sensor, in which housing the at least one radar sensor is at least partially or regionally accommodated,
wherein the housing associated with the at least one radar sensor is at least partially or regionally formed by a housing structure (1) according to claim 1.
